(19) United States
(12) Patent Application Publication
(10) Pub. No.: US 2010/0090425 A1
(43) Pub. Date: Apr. 15, 2010

(54) RECREATIONAL PERSONAL VEHICLE FOR SLIDING

(76) Inventor: Alon Karpman, Brooklyn, NY (US)

Correspondence Address: MEREDITH & KEYHANI, PLLC, 330 MADISON AVE., 6TH FLOOR, NEW YORK, NY, 10017, US

(21) Appl. No.: 12/569,795

(22) Filed: Sep. 29, 2009

Related U.S. Application Data
(60) Provisional application No. 61/104,853, filed on Oct. 13, 2008.

(51) Int. Cl. B62B 13/02

(52) U.S. Cl. 280/14.22; 280/14.21

(57) ABSTRACT

A stand-on recreational personal vehicle device for sliding. The device may be used for sliding on ice or snow in activities resembling skiing or snowboarding. The device includes one or two boards, two foot straps for holding down feet of the rider to the boards, one or two foot platforms for supporting the feet of the rider, and one or two risers for coupling the foot platforms to the boards and providing a distance between the foot platforms and the boards. When two boards are used, a spring connecting rod couples the two boards together. Pivot joints may be used to connect the rod to the boards, or to the foot platforms, that permit the two boards to move with respect to each other from a parallel position to an aligned position. The rod and the board may be adapted for twisting, bending or both.

### CROSS-REFERENCE TO RELATED APPLICATIONS

The present application claims priority to and the benefit of the U.S. Provisional Patent Application No. 61/104,853, filed in the United States Patent and Trademark Office on Oct. 13, 2008, the entire content of which is incorporated by this reference.

### BACKGROUND OF THE INVENTION

1. Field of the Invention

The present invention pertains generally to the field of personal vehicles and, more particularly, to sliding stand-on recreational personal vehicles that include skis and snowboards.

2. Description Of Related Art

Skis and snowboards are two types of sliding stand-on vehicles that are used by one person for recreational purposes. In skiing, the rider uses two separate ski boards and straps or binds one ski to each foot. Skiers additionally use poles. In snowboarding, both feet are strapped or bound to the same board. In skiing, the two skis are generally in a parallel or near parallel position as the skier slides down the hill and the skier's feet are aligned with the length of the ski. In snowboarding, the snowboarder stands somewhat transverse to the length of the board such that he has to turn slightly to face downhill.

In both skiing and snowboarding, the position of the feet with respect to the sliding board, be it ski or snowboard, is fixed. In both skiing and snowboarding, the feet are substantially on the sliding board, separated from the board by the thickness of the binding.

The two activities of skiing and snowboarding have some overlaps. However, there are also moves that are peculiar to one or the other or may be performed more easily with one than the other. Therefore, each of the two activities of skiing and snowboarding provides certain maneuverability and certain limitations for the rider.

### SUMMARY OF THE INVENTION

Aspects of the present invention provide a highly maneuverable stand-on recreational personal vehicle device that may be used for sliding over snow or ice. In that sense, the device may be used in activities resembling skiing or snowboarding with maneuverability that exceeds either skiing or snowboarding and without some of the limitations of skiing or snowboarding.

One aspect of the present invention provides a device including one or two sliding boards, two foot straps for holding down feet of the rider to the sliding boards, one or two foot platforms for supporting the feet of the rider, and one or two risers for coupling the foot platforms to the single sliding board or the two sliding boards and providing a distance between the foot platforms and the board. When two boards are used, a spring connecting rod couples the two boards together. The boards may be coupled together at the foot platforms. Pivot joints may be used to connect the spring connecting rod to the boards, or to the foot platforms. These pivot joints permit the two boards to move with respect to each other going from a parallel position to a substantially aligned position. The joints permit easy turning by the rider. They also permit folding of the device for carrying. The rod may be made from a material that is adapted for twisting, bending or both. The risers provide a distance between the rider's feet and the snow and allow the rider to have enhanced maneuverability. The risers may be rigid or they may also be made from a material is adapted for twisting, bending or both. The risers may be left out such that there is little distance between the feet of the rider and the boards.

One aspect of the present invention provides a personal vehicle for carrying a rider, the device including two boards, two foot straps for holding down feet of the rider to the boards, two foot platforms coupled to the boards for supporting the feet of the rider, and a spring connecting rod coupling the two boards together. The spring connecting rod couples the two boards together in a manner to allow the two boards to lie in positions with respect to each other varying from substantially parallel to substantially aligned.

In one aspect, the spring connecting rod couples the boards together by coupling the foot platforms together, the spring connecting rod is coupled to each of the two foot platforms through a pivoting joint, and each pivoting point is a joint allowing the rider to turn and allowing the device to fold for carrying. The spring connecting rod may be adapted for twisting, bending or both. In one aspect the device further includes two risers for coupling the foot platforms to the boards and providing a distance between the foot platforms and the respective boards and the risers raise the rider above the boards to provide leverage for easy turning. In one aspect, a distance between the two foot platforms is adapted to being adjusted to be wider or narrower according to a height of the rider. In one aspect, each of the foot straps is adjustably fixed to the respective foot platform. In one aspect, each of the foot straps is adapted to rotate with respect to the respective foot platform. In one aspect, each of the foot straps includes a top portion fitting over the foot, a bottom portion fitting over the foot platform, and a mechanism for coupling the bottom portion to the foot platform permitting the foot strap to rotate with respect to the foot platform or to remain adjustably fixed to the foot platform. In one aspect, each of the risers are adapted for twisting, bending or both. In one aspect, the boards are adapted for twisting, bending or both.

One aspect of the present invention provides a personal vehicle for carrying a rider, the device including one board, two foot straps for holding down feet of the rider to the board, two foot platforms for supporting the feet of the rider, and two risers for coupling the foot platforms to the board and providing a distance between the foot platforms and the board. The risers raise the rider above the board to reduce scraping the snow as the rider turns and to provide leverage for easy turning. In one aspect, the risers are adapted for twisting, bending or both. In one aspect, the board is adapted for twisting, bending or both. In one aspect, a distance between the two foot straps is narrower according to a height of the rider. In one aspect, each of the foot straps is adjustably fixed to respective foot platform. In one aspect, each of the foot straps is adapted to rotate with respect to respective foot platform.

One aspect of the present invention provides a personal vehicle for carrying a rider, the device including one board, two foot straps for holding down feet of the rider to the board, one foot platform for supporting the feet of the rider, and one riser for coupling the foot platform to the board and providing a distance between the foot platform and the board. The riser raises the rider above the board to reduce scraping the snow as the rider turns and to provide leverage for easy turning. In one aspect, a distance between the two foot straps is adapted to being adjusted to be wider or narrower according to a height of the rider. In one aspect, each of the foot straps is adjustably fixed to the foot platform. In one aspect, each of the foot straps is adapted to rotate with respect to the foot platform. In one aspect, each of the foot straps includes a top portion fitting over the foot, a bottom portion fitting over the foot platform, and a mechanism for coupling the bottom portion to the foot platform permitting the foot strap to rotate with respect to the foot platform or remain adjustably fixed to the foot platform. In one aspect, the riser is adapted for twisting, bending or both. In one aspect, the board is adapted for twisting, bending or both.

In various aspects of the present invention, the risers are 2 to 14 inches high. In one aspect of the present invention, the riser is 5 inches high. In another aspect, the riser is 9 inches high. The dimension of the riser is determined according to the height of the user and his skill. Higher risers provide a larger lever arm and more maneuverability to the user. By the same token, they may be more suitable for a user who is capable of taking advantage of the added moment arm.

### BRIEF DESCRIPTION OF THE DRAWINGS

FIG. 1A shows a schematic plan view of one exemplary embodiment of a device, according to aspects of the present invention.

FIG. 1B shows a photograph of one exemplary embodiment of a device, according to aspects of the present invention.

FIG. 2A shows a schematic plan view of the exemplary embodiment of FIG. 1A in a different position.

FIG. 2B shows another photograph of the exemplary embodiment shown in FIG. 1B.

FIG. 3 shows a schematic side perspective view of the exemplary embodiment of FIG. 1A, according to aspects of the present invention.

FIG. 4 shows a schematic side perspective view of another exemplary device including one board, according to aspects of the present invention.

FIG. 5 shows a schematic side perspective view of yet another exemplary device including one board and one foot platform, according to aspects of the present invention.

### DETAILED DESCRIPTION OF THE INVENTION

Aspects of the present invention provide a highly maneuverable recreational personal device for sliding on snow or ice. The devices of the embodiments of the present invention include some of the advantages of both skis and snowboards while excluding some disadvantages of these devices.

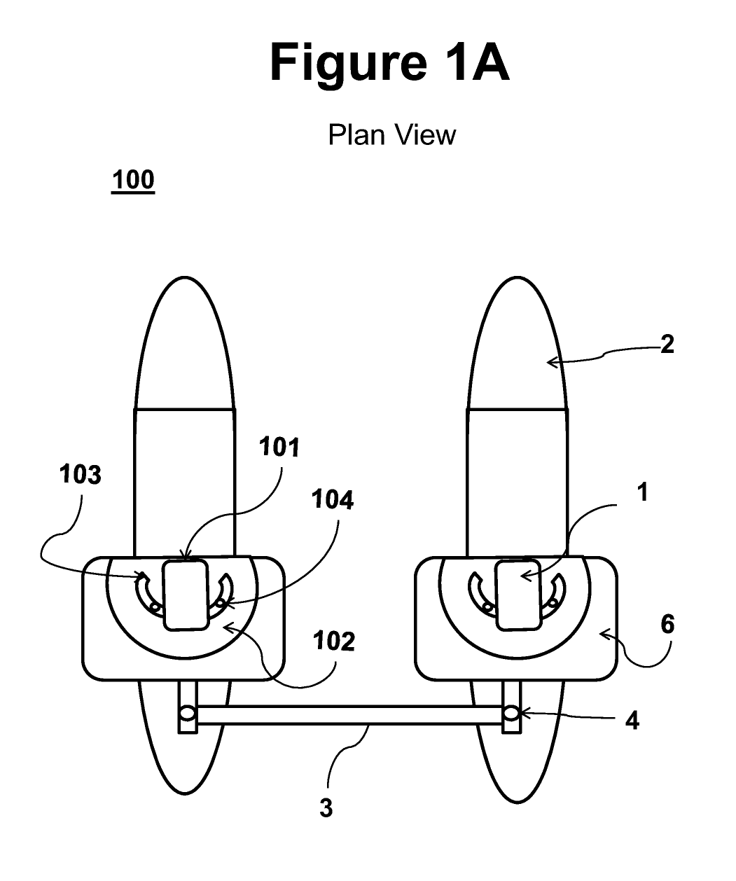

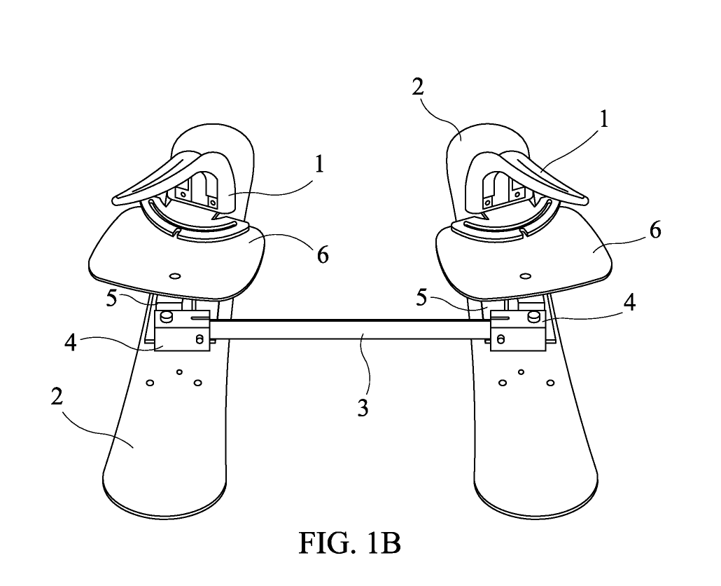

FIG. 1A shows a schematic plan view of one exemplary embodiment of a device, according to aspects of the present invention.

In one exemplary embodiment, the device 100 includes two foot straps 1, two sliding boards 2, a spring connecting rod 3, two pivoting joints 4, a riser 5 for each foot and a foot platform 6 for each foot.

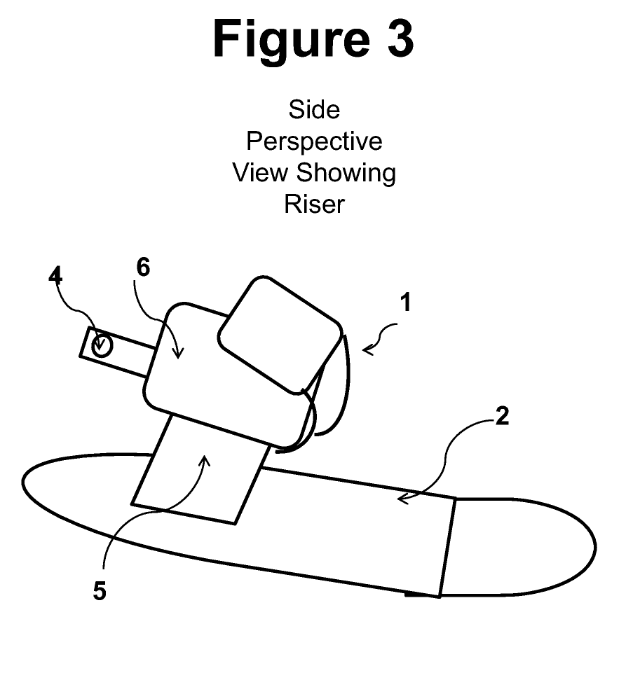

The risers 5 are placed between the boards 2 and the foot platforms 6 to elevate the foot platforms above the boards. Therefore, the risers 5 cannot be seen in the plan view of FIG. 1A and are shown in the side view in FIG. 3. In various aspects of the present invention, the risers are between 2 inches to 14 inches high. Additionally, a top portion of the foot straps 1 and the foot platforms 6 are separated along the vertical by a distance to allow a foot to fit between the two. This elevation distance is shown in FIG. 3.

Each of the two foot straps 1 holds down one foot of the rider. Each foot strap 1 is coupled to one of the two boards 2. The boards 2 may be similar to skis or snowboards. For each foot strap 1, a foot platform 6 is included for the rider to stand on.

The spring connecting rod 3 couples the two boards 2 together by coupling together the foot platforms 6. The spring connecting rod 3 is capable of twisting and bending. In other aspects of the present invention (not shown), the spring connecting rod may connect the boards directly instead of connecting the foot platforms.

In the embodiment shown, each of the foot platforms 6 are coupled to the spring connecting rod 3 through a pivoting joint 4. The pivoting joint 4 provides a joint that allows the rider to turn and also allows the device to fold for easy carrying.

For each foot platform 6, a riser 5 is included. The riser 5 is a platform to raise the rider above the sliding boards 2. The risers 5 also help the feet not to scrape the snow as the rider turns and provide leverage for easy turning. The risers may be between 2 and 14 inches high. A range between 5 and 9 inches is more useable for most users.

In one aspect of the present invention, the distance between the foot platforms 6 can be adjusted according to rider's height to be wider for a taller person and narrower for a shorter person.

In one aspect of the present invention, the foot strap 1 is coupled to the foot platform 6 in a fixed but adjustable manner that permits the position of the foot to be adjusted with respect to the foot platform 6 but does not permit the foot to rotate with respect to the foot platform 6 during the riding of the device.

In one aspect of the present invention, the foot strap 1 is coupled to the foot platform 6 in a manner that permits the foot to rotate with respect to the foot platform 6. In the exemplary embodiment shown in FIG. 1A, the foot strap 1 includes a top portion 101 coupled to a bottom portion 102. The bottom portion is shown as a semi-circular portion in FIG. 1A. The bottom portion 102 includes one or more grooves 103 and one or more pins or screws 104 that move in the grooves 103 and permit the foot to rotate with respect to the foot platform 6. The pins or screws 104 may also be used to fix the position of the foot strap 1 with respect to the foot platform 6.

The mechanism shown is exemplary and other mechanisms for coupling the foot strap 1 to the foot platform 6 may be used that permit the foot to rotate with respect to the foot platform 6. For example, in one aspect of the present invention, the foot strap 1 may be fixed to the foot platform 6 and the riser 5 while the riser 5 may be rotatably coupled to the board 2. One aspect of the present invention may do away with the risers and the platforms may be coupled to the boards without having to go through the risers as intermediaries.

One way the device is distinguished from skis is that the two sliding boards of the device are coupled together through the spring connecting rod.

One way the device is distinguished from a snowboard is that, in some embodiments, the device may use two boards.

One way the device is distinguished from a snowboard is that due to the twisting and bending capabilities of the spring connecting rod, the two feet have maneuverability with respect to each other and therefore with respect to the boards. This is distinguished from snowboards where the two feet are fixed to the board in one position.

One way the device is distinguished from skis and snowboards is that the feet are raised above the sliding boards of the device by the distance of the risers while with skis and snowboards the feet lie in the binding which is substantially directly on the ski or the snowboard.

One way the device is distinguished from skis and snowboards is that, in some embodiments, the foot may rotate with respect to the board while in both skiing and snowboarding, the feet are bound to the skis and the snowboard.

One way the device is distinguished from skis and snowboards is that if the foot strap is coupled to the device such that the foot may rotate in the plane of the foot platform and if additionally the riser or risers are capable of bending or twisting or both, then the feet have some level of freedom to rotate to some degree about all three axes of a three-dimensional Cartesian coordinate system.

One way the device is distinguished from skis and snowboards is that the two sliding boards of the device may lie parallel similar to skis or may be aligned similar to a snowboard such that the rider may switch between the motions and maneuvers reserved to skiers and those reserved to snowboarders.

FIG. 1B shows a photograph of one exemplary embodiment of a device, according to aspects of the present invention.

A photograph of one exemplary embodiment including two sliding boards and the associated other elements is shown in FIG. 1B. The photograph substantially corresponds to the drawing of FIG. 1A.

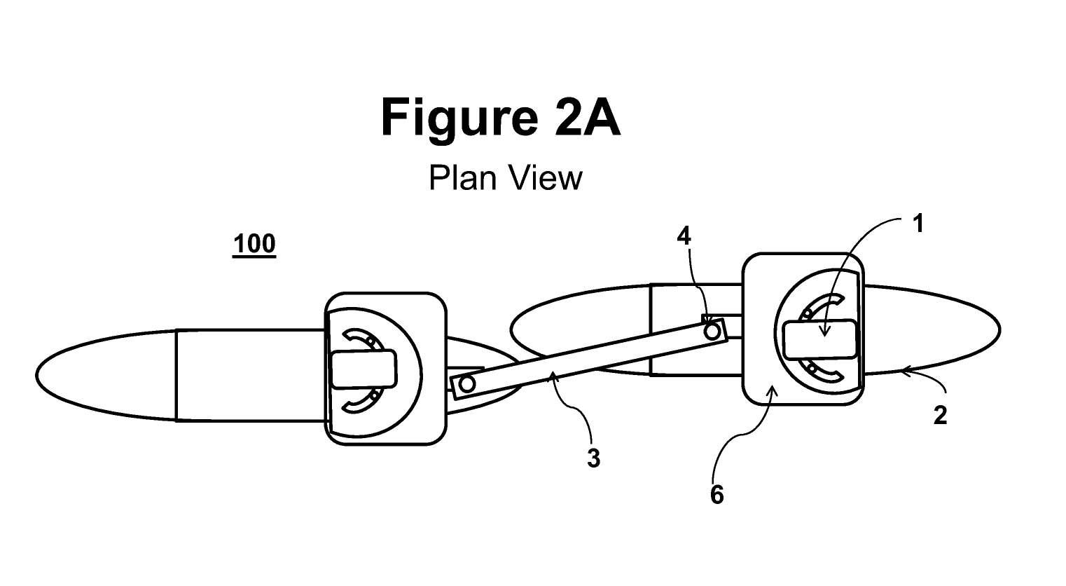

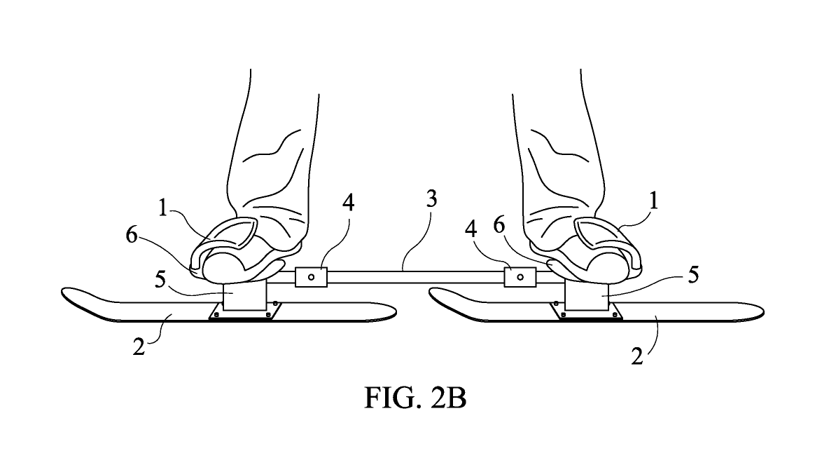

FIG. 2A shows a schematic plan view of the exemplary embodiment of FIG. 1A in a different position.

The plan view of FIG. 2A shows the two boards in a somewhat aligned position. The spring connecting rod 3, the pivots 4 and the rotation of the foot strap 1 on the foot platform 6 permits the two skis or boards to lie parallel as shown in FIG. 1A or in an aligned or substantially aligned position as shown in FIG. 2A. In the parallel position, the device resembles a pair of skis. In the aligned position, the device resembles a snowboard.

Yet, whether in the parallel position or the aligned position or anywhere in between, the device is distinguished from both skis and snowboards in several different ways. For example, the two feet are coupled through the spring connecting rod which is capable of bending and twisting. Therefore, the two feet can bend and twist with respect to each other as they could in skiing but not in snowboarding. In one aspect of the present invention, the semi-circular portion of the foot strap permits the foot strap, and therefore the foot, to rotate with respect to the board. This rotation is not possible in either skiing or snowboarding. The distance that the risers provide between the snow and the foot provides a lever arm between the feet and the boards which leads to added power and maneuverability. This lever arm effect is not present in either skiing or snowboarding.

The capability to switch between the moves of skiing and the moves of snowboarding is also absent when skis or snowboards are used.

FIG. 2B shows another photograph of the exemplary embodiment shown in FIG. 1B.

The photograph shown in FIG. 2B corresponds to the substantially aligned position of the two boards as shown in FIG. 2A.

FIG. 3 shows a schematic side perspective view of the exemplary embodiment of FIG. 1A, according to aspects of the present invention.

One of the two risers 5 appears in the side view shown in FIG. 3. The riser 5 couples the foot platform 6 to the board 2 and provides a distance between the foot platform 6, where the foot rests, and the snow. This distance separates the rider's foot from the snow and additionally provides improved maneuverability and power for the rider. This distance may be between 2 inches to 14 inches depending on the riser.

In the perspective view shown in FIG. 3, the distance between the upper portion of the foot strap 1, which holds the foot down, and the foot platform 6, which provides support for the foot, is also shown.

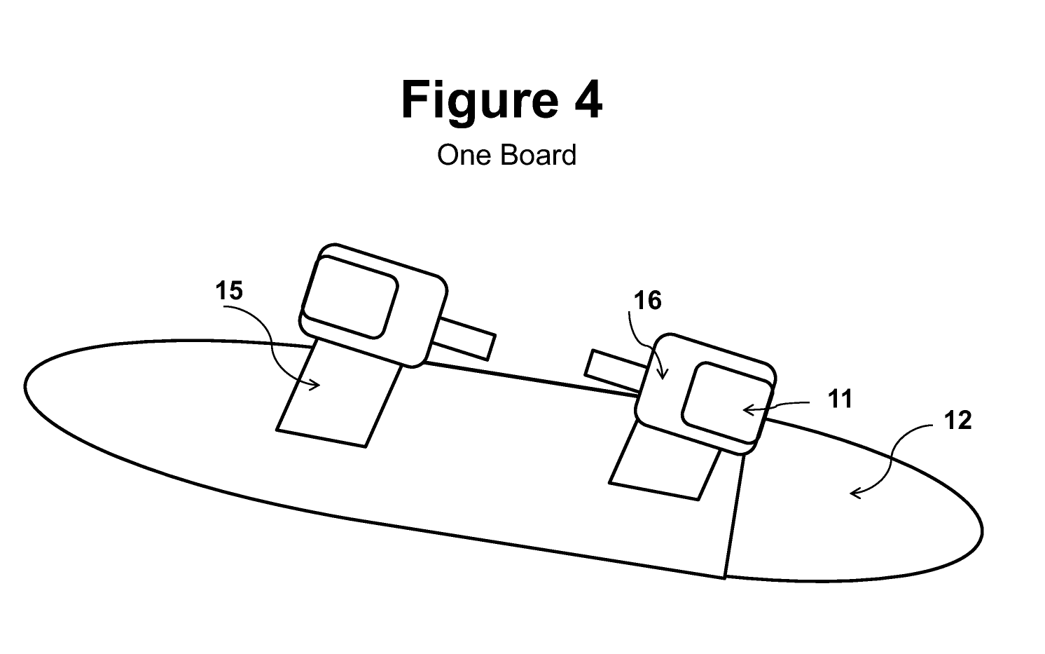

FIG. 4 shows a schematic side perspective view of another exemplary device including one board, according to aspects of the present invention.

The exemplary embodiment shown in FIG. 4 includes two foot straps 11, one single sliding board 12, two risers 15 and two foot platforms 16. This exemplary embodiment uses one board and both foot platforms 16 are mounted on the same sliding board. Accordingly, this embodiment is more similar to a snowboard than a ski. This embodiment is different from a snowboard in several ways. For example, the two feet have maneuverability with respect to the board due to the lever arm provided by the risers. In one aspect of the present invention, the foot straps 11 may rotate with respect to the foot platform 16 at least by some degrees. Therefore, the feet may rotate in the plane of the foot platform 16. Further, in one aspect of the present invention, the risers 15 are made from a material that is capable of twisting and bending and provides a third degree of freedom to the feet.

The spring connecting rod 3 shown in the embodiment of FIG. 1A, provided a connection between the two boards that had some degree of flexibility. This connecting rod and the associated pivots may be entirely absent from the embodiment of FIG. 4 that includes only one single board. In the embodiment of FIG. 4, the foot platforms 16 may still be moved closer or farther depending on the how tall the rider is.

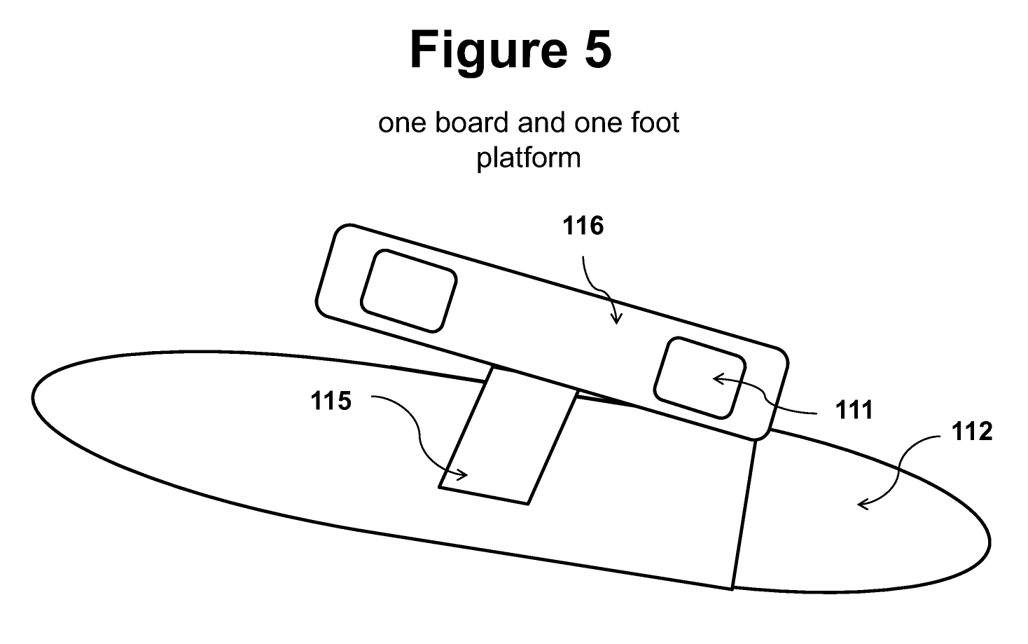

FIG. 5 shows a schematic side perspective view of yet another exemplary device including one board and one foot platform, according to aspects of the present invention.

In one aspect of the present invention where only one board 112 is used, only one foot platform 116 may be used for supporting both feet while the two foot straps 111 may be moved closer or farther on the foot platform. Then, only one riser 115 may be used to couple the foot platform 116 to the board 112.

Several equivalent combinations are possible. For example, in various embodiments described above, the foot straps and the foot platforms may be one component, for example called a foot holder. The adjustability of the position of the foot holders with respect to each other may be obtained through the connection between the foot holders and the risers or the connection between the risers and the boards. Along the same lines, the functions of all three components of foot strap, foot platform and riser may be combined into one component. In that case, this component may be moved closer or farther on the boards according to how tall the rider is. The same single component may be adjustably fixed to the board such that it stays affixed during the ride. Alternatively, this single component may be connected to the board such that it may rotate with respect to the board due to pressure exerted by the rider's foot while the rider is riding the device. Finally, when two boards are used, they may connected by the spring connecting rod either directly or through this single component.

The present invention has been described in relation to particular examples, which are intended to be illustrative rather than restrictive, with the scope and spirit of the invention being indicated by the following claims and their equivalents.

1. A personal vehicle for carrying a rider, the device comprising:
two boards;
two foot straps for holding down feet of the rider to the boards;
two foot platforms coupled to the boards for supporting the feet of the rider; and
a spring connecting rod coupling the two boards together,
wherein the spring connecting rod couples the two boards together in a manner to allow the two boards to lie in positions with respect to each other varying from substantially parallel to substantially aligned.

2. The device of claim 1,
Wherein the spring connecting rod couples the boards together by coupling the foot platforms together,
wherein the spring connecting rod is coupled to each of the two foot platforms through a pivoting joint, and
wherein each pivoting point is a joint allowing the rider to turn and allowing the device to fold for carrying.

3. The device of claim 1, wherein the spring connecting rod is adapted for twisting, bending or both.

4. The device of claim 1, further comprising:
two risers for coupling the foot platforms to the boards and providing a distance between the foot platforms and the respective boards,
wherein the risers raise the rider above the boards to provide leverage for easy turning.

5. The device of claim 1, wherein a distance between the two foot platforms is adapted to being adjusted to be wider or narrower according to a height of the rider.

6. The device of claim 1, wherein each of the foot straps is adjustably fixed to the respective foot platform.

7. The device of claim 1, wherein each of the foot straps is adapted to rotate with respect to the respective foot platform.

8. The device of claim 1, wherein each of the foot straps includes:
a top portion fitting over the foot;
a bottom portion fitting over the foot platform; and
a mechanism for coupling the bottom portion to the foot platform permitting the foot strap to rotate with respect to the foot platform or to remain adjustably fixed to the foot platform.

9. The device of claim 4, wherein each of the risers are adapted for twisting, bending or both.

10. The device of claim 1, wherein each of the boards are adapted for twisting, bending or both.

11. A personal vehicle for carrying a rider, the device comprising:
one board;
two foot straps for holding down feet of the rider to the board;
two foot platforms for supporting the feet of the rider; and
two risers for coupling the foot platforms to the board and providing a distance between the foot platforms and the board,
wherein the risers raise the rider above the board to reduce scraping the snow as the rider turns and to provide leverage for easy turning.

12. The device of claim 11, wherein the risers are adapted for twisting, bending or both.

13. The device of claim 11, wherein a distance between the two foot straps is adapted to being adjusted to be wider or narrower according to a height of the rider.

14. The device of claim 11, wherein each of the foot straps is adjustably fixed to respective foot platform.

15. The device of claim 11, wherein each of the foot straps is adapted to rotate with respect to respective foot platform.

16. The device of claim 11, wherein the board is adapted for twisting, bending or both.

17. A personal vehicle for carrying a rider, the device comprising:
one board;
two foot straps for holding down feet of the rider to the board;
one foot platform for supporting the feet of the rider; and
one riser for coupling the foot platform to the board and providing a distance between the foot platform and the board,
wherein the riser raises the rider above the board to reduce scraping the snow as the rider turns and to provide leverage for easy turning.

18. The device of claim 17, wherein a distance between the two foot straps is adapted to being adjusted to be wider or narrower according to a height of the rider.

19. The device of claim 17, wherein each of the foot straps is adjustably fixed to the foot platform.

20. The device of claim 17, wherein each of the foot straps is adapted to rotate with respect to the foot platform.

21. The device of claim 17, wherein each of the foot straps includes:
a top portion fitting over the foot;
a bottom portion fitting over the foot platform; and
a mechanism for coupling the bottom portion to the foot platform permitting the foot strap to rotate with respect to the foot platform or remain adjustably fixed to the foot platform.

22. The device of claim 17, wherein the riser is adapted for twisting, bending or both.

23. The device of claim 17, wherein the board is adapted for twisting, bending or both.
